(19) United States
(12) Patent Application Publication
(10) Pub. No.: US 2013/0218759 A1
(43) Pub. Date: Aug. 22, 2013

(54) VIRTUAL TRANSACTION CUTOFF

(71) Applicant: Bank of America Corporation, (US)

(72) Inventors: Jennifer Kendrick Anthony, Charlotte, NC (US); Brent Beecher Allen, Charlotte, NC (US)

(73) Assignee: BANK OF AMERICA CORPORATION, Charlotte, NC (US)

(21) Appl. No.: 13/841,473

(22) Filed: Mar. 15, 2013

Related U.S. Application Data
(63) Continuation-in-part of application No. 13/011,715, filed on Jan. 21, 2011.

(51) Int. Cl. G06Q 20/22

(52) U.S. Cl. CPC G06Q 20/22
USPC 705/39

(57) ABSTRACT

In some embodiments of the present invention, a method is provided that includes: (a) receiving transaction information associated with a transaction; (b) determining, based at least partially on the transaction information, that the transaction involves an account, occurred after a daily cutoff time on a first day, has a predetermined transaction type, and includes a transaction amount; and (c) designating, using a processor and based at least partially on the determining that the transaction occurred after the daily cutoff time and has the predetermined transaction type, the transaction amount for inclusion in the daily ending balance for the account for the first day. In some embodiments, the method further includes designating, based at least partially on the determining that the transaction occurred after the daily cutoff time, the transaction for posting to the account on a second day, where the second day is any day after the first day.

### CROSS-REFERENCE TO RELATED APPLICATIONS

The present application is a continuation-in-part application of, and claims priority to, U.S. patent application Ser. No. 13/011,715, which was filed on Jan. 21, 2011, and is titled “Virtual Transaction Cutoff,” and is incorporated by reference herein in its entirety.

### BACKGROUND

It is well known that large financial institutions process millions of transactions every single day. In an ideal world, these institutions would be able to perform these processing functions in real time, but this is typically not possible where there are millions of transactions to process and relatively limited computing resources available to perform the processing. As a result, many large financial institutions must process transactions some time after those transactions actually occur. In such cases, financial institutions often rely on batch jobs that are executed periodically (e.g., daily, weekly, and the like) in order to post transactions to accounts, determine daily ending balances, and otherwise process financial transactions. Accordingly, there is a need to provide methods and apparatuses for processing transactions in a batch processing environment that more closely resembles real-time transaction processing.

### SUMMARY OF SELECTED EMBODIMENTS OF THE PRESENT INVENTION

In general terms, embodiments of the present invention relate to methods and apparatuses for processing transactions. More specifically, some embodiments of the present invention are directed to processing transactions in a batch processing environment that more closely resembles real-time transaction processing. In addition, some embodiments of the present invention are directed to mitigating the disadvantages of using daily cutoff times in a batch processing environment without substantially disrupting the existing batch processing environment needed to process financial transactions on a daily basis. To accomplish these and other objectives, some embodiments of the present invention are configured to determine a daily ending balance for an account for a first day based at least partially on at least some transactions that involve the account and occur after a daily cutoff time on the first day. In some embodiments, these after-cutoff transactions are represented in the daily ending balance for the first day, even though the after-cutoff transactions do not post to the account until a second day (i.e., any day after the first day). As a result, an account may be prevented from incurring an exceeded account threshold (e.g., surpassed balance, exceeded credit threshold amount, unavailable funds, unsuccessfully clearing a check, and the like) and/or a related exceeded account threshold payment that would have been incurred in a conventional batch processing environment.

For example, some embodiments of the present invention provide a method that includes: (a) receiving transaction information associated with a transaction; (b) determining, based at least partially on the transaction information, that the transaction involves an account, occurred after a daily cutoff time on a first day, has a predetermined transaction type, and includes a transaction amount; and (c) designating, using a processor and based at least partially on the determining that the transaction occurred after the daily cutoff time and has the predetermined transaction type, the transaction amount for inclusion in the daily ending balance for the account for the first day.

In some embodiments, the method further includes designating, based at least partially on the determining that the transaction occurred after the daily cutoff time, the transaction for posting to the account on a second day, where the second day is any day after the first day. In some embodiments, the method further includes posting the transaction to the account on the second day. For example, in some embodiments, the posting the transaction to the account on the second day includes assigning a posting date to the transaction, where the posting date is the second day.

In some embodiments, the method further includes configuring a batch job for processing, where the configuring includes inputting a determined amount into the batch job, where the determined amount is based at least partially on the transaction amount, and where the batch job, when executed by a processor, causes the processor to determine the daily ending balance based at least partially on the determined amount. In some embodiments, the determined amount is the transaction amount. In other embodiments, the determined amount is a net amount, i.e., the determined amount is the sum of the transaction amount and one or more other transaction amounts, where the one or more other transaction amounts are associated with one or more transactions that involve the account, occurred after the daily cutoff time on the first day, and have the predetermined transaction type.

In some embodiments, the method also includes determining, using a processor, the daily ending balance based at least partially on the transaction amount. In other embodiments, the method additionally or alternatively includes posting the daily ending balance to an electronic banking account (e.g., online banking account, mobile banking account, and the like) associated with the account. In some embodiments, the method further includes determining, using a processor and based at least partially on the daily ending balance, that the account has incurred an exceeded account threshold. In still other embodiments, the method further includes assessing, based at least partially on the determining that the account has incurred the exceeded account threshold, a payment associated with the exceeded account threshold. Also, in some embodiments, the predetermined transaction type includes a cash-related transaction (e.g., at least one of a cash withdrawal, cash deposit, or funds transfer, and the like).

In some embodiments, the method further includes: (a) receiving second transaction information associated with a second transaction; (b) determining, based at least partially on the second transaction information, that the second transaction involves the account, occurred before the daily cutoff time on the first day, and has a second transaction amount; and (c) designating, using a processor and based at least partially on the determining that the second transaction occurred before the daily cutoff time, the second transaction amount for inclusion in the daily ending balance. In some of these embodiments, the method further includes designating, based at least partially on the determining that the second transaction occurred before the daily cutoff time, the second transaction for posting to the account on the first day.

In other embodiments, the method includes: (a) receiving second transaction information associated with a second transaction; (b) determining, based at least partially on the second transaction information, that the second transaction involves the account, occurred after the daily cutoff time on the first day, has a second transaction amount, and does not have the predetermined transaction type; and (c) designating, using a processor and based at least partially on the determining that the second transaction occurred after the daily cutoff time and does not have the predetermined transaction type, the second transaction amount for inclusion in the daily ending balance for the account for a second day, where the second day is any day after the first day.

In still other embodiments, the transaction was conducted through a first channel, the daily cutoff time is associated with the first channel, and the method further includes: (a) receiving second transaction information associated with a second transaction; (b) determining, based at least partially on the second transaction information, that the second transaction involves the account, has a second transaction amount, and occurred after the daily cutoff time but before a second daily cutoff time on the first day, where the second daily cutoff time is associated with a second channel through which the second transaction was conducted; and (c) designating, using a processor and based at least partially on the determining that the second transaction occurred before the second daily cutoff time, the second transaction amount for inclusion in the daily ending balance.

As another example, some embodiments of the present invention provide an apparatus that includes: (a) a communication interface configured to receive transaction information associated with a transaction; and (b) a processor operatively connected to the communication interface and configured to: (i) determine, based at least partially on the transaction information, that the transaction involves an account, occurred after a daily cutoff time on a first day, has a predetermined transaction type, and includes a transaction amount; and (ii) designate, based at least partially on the processor determining that the transaction occurred after the daily cutoff time and has the predetermined transaction type, the transaction amount for inclusion in the daily ending balance for the account for the first day.

As still another example, some embodiments of the present invention provide a computer program product having a non-transitory computer-readable medium. In some embodiments, the non-transitory computer-readable medium includes one or more computer-executable program code portions that, when executed by a computer, cause the computer to: (a) receive transaction information associated with a transaction; (b) determine, based at least partially on the transaction information, that the transaction involves an account, occurred after a daily cutoff time on a first day, has a predetermined transaction type, and includes a transaction amount; and (c) designate, based at least partially on the computer determining that the transaction occurred after the daily cutoff time and has the predetermined transaction type, the transaction amount for inclusion in the daily ending balance for the account for the first day.

As another example, some embodiments of the present invention provide a system that includes a decisioning apparatus configured to: (a) receive transaction information associated with a first group of transactions involving an account; (b) determine, based at least partially on the transaction information, that each transaction in the first group occurred after a daily cutoff time on a first day, has a predetermined transaction type, and includes a transaction amount; (c) determine, based at least partially on determining that each of the transactions in the first group occurred after the daily cutoff time and has the predetermined transaction type, that the daily ending balance for the account for the first day should be based at least partially on the transactions in the first group; (d) determine, based at least partially on determining that the daily ending balance should be based at least partially on the transactions in the first group, a net amount for the first group, where the net amount includes the sum of the transaction amounts in the first group; and (e) configure a batch job for processing by inputting the net amount into the batch job. Additionally, in some embodiments, the system includes a batch processing apparatus operatively connected to the decisioning apparatus and configured to: (a) receive the batch job; and (b) execute the batch job to determine the daily ending balance for the account for the first day based at least partially on the net amount.

As yet another example, some embodiments of the present invention provide a method that includes: (a) receiving transaction information associated with a transaction; (b) determining, based at least partially on the transaction information, that the transaction involves an account, occurred after a daily cutoff time on a first day, and includes a transaction amount; (c) determining, using a processor, a daily ending balance for the account for the first day based at least partially on the transaction amount; and (d) posting the transaction to the account on a second day, where the second day is any day after the first day.

### BRIEF DESCRIPTION OF THE DRAWINGS

Having thus described some embodiments of the present invention in general terms, reference will now be made to the accompanying drawings, wherein:

FIG. 1 is a flow diagram illustrating a general process flow for processing a transaction that involves an account and occurred after a daily cutoff time, in accordance with an embodiment of the present invention;

FIGS. 2-2A is a flow diagram illustrating a general process flow for processing one or more transactions based at least partially on a daily cutoff time, in accordance with an embodiment of the present invention;

FIG. 3 is a block diagram illustrating technical components of a system for processing transactions based at least partially on one or more daily cutoff times, in accordance with an embodiment of the present invention; and

FIG. 4 is a mixed block and flow diagram illustrating technical components of a system for processing multiple transactions based at least partially on two different daily cutoff times, in accordance with an embodiment of the present invention.

### DETAILED DESCRIPTION OF EMBODIMENTS OF THE PRESENT INVENTION

In general terms, embodiments of the present invention relate to methods and apparatuses for processing transactions. It is well known that large financial institutions process millions of transactions every single day. In an ideal world, these institutions would be able to perform these processing functions in real time, but this is typically not possible where there are millions of transactions to process and relatively limited computing resources available to perform the processing. As a result, many large financial institutions must process transactions some time after those transactions actually occur. In such cases, financial institutions often rely on batch jobs that are executed periodically (e.g., daily, weekly, and the like) in order to post transactions to accounts, determine daily ending balances, and otherwise process financial transactions.

As used herein, the phrase “batch job” generally refers to one or more programs that can be executed by a computer with little or no human intervention. In a typical batch processing environment, input data is collected into a batch job, the batch job is sent to a batch processing apparatus, and the batch processing apparatus executes the batch job to produce output data. As an example, a batch job may include transaction information associated with an account (input data) and be executed to produce a daily ending balance for the account (output data). Because batch jobs can be executed with little or no human intervention, financial institutions typically use batch jobs to automate regular tasks, such as, for example, processing transactions, updating files, completing print jobs, creating reports, and/or the like. In addition, financial institutions typically schedule batch jobs for execution during off-peak hours (e.g., at night) when most computing resources are not being used to perform other functions.

Given the various benefits of batch processing, many financial institutions schedule daily batch jobs to process the transactions that occurred earlier that day. However, not all of the transactions that actually occurred that day are represented in the daily batch job because, for example, time is needed to configure the batch job for processing and then actually execute the batch job. As such, financial institutions often define a “daily cutoff time” for processing transactions, which generally refers to the latest time by which a transaction involving an account can occur and still be posted to the account that day. Daily cutoff times are typically defined by transaction type and can vary considerably. For example, the daily cutoff time for automated teller machine (ATM) transactions may be 8:00 pm, but the daily cutoff time for transactions performed using an electronic banking account (e.g., online banking account, mobile banking account, SMS banking account, and the like) may be 10:45 pm.

Unfortunately, differences in daily cutoff times can lead to disparities in transaction processing and confusion among financial institution customers. For example, consider a situation where a customer deposits cash into her deposit account at an ATM at 8:30 pm and then uses her online banking account to transfer funds out of her deposit account at 9:30 pm. In such a case, if the daily cutoff time for ATM transactions is 8:00 pm and the daily cutoff time for online banking transactions is 10:45 pm, then the customer's online banking funds transfer transaction may be included in the daily ending balance for the deposit account but her ATM deposit transaction may not. If the funds transfer transaction is included but the deposit transaction is not, then the customer may surpass the available balance of her account, even though her deposit transaction actually occurred earlier in time than her funds transfer transaction.

In view of these issues, some embodiments of the present invention are directed to mitigating the disadvantages of using daily cutoff times in a batch processing environment without substantially disrupting the existing batch processing environment needed to process financial transactions on a daily basis. In addition, some embodiments of the present invention are directed to processing transactions in a batch processing environment that more closely resembles real-time transaction processing. To accomplish these and other objectives, some embodiments of the present invention are configured to determine a daily ending balance for an account for a first day based at least partially on at least some transactions that involve the account and occur after a daily cutoff time on the first day. In some embodiments, these after-cutoff transactions are represented in the daily ending balance for the first day, even though these after-cutoff transactions do not post to the account until a second day (i.e., any day after the first day). As a result, an account may be prevented from incurring an exceeded account threshold and/or a related exceeded account threshold payment that would have been incurred in a conventional batch processing environment.

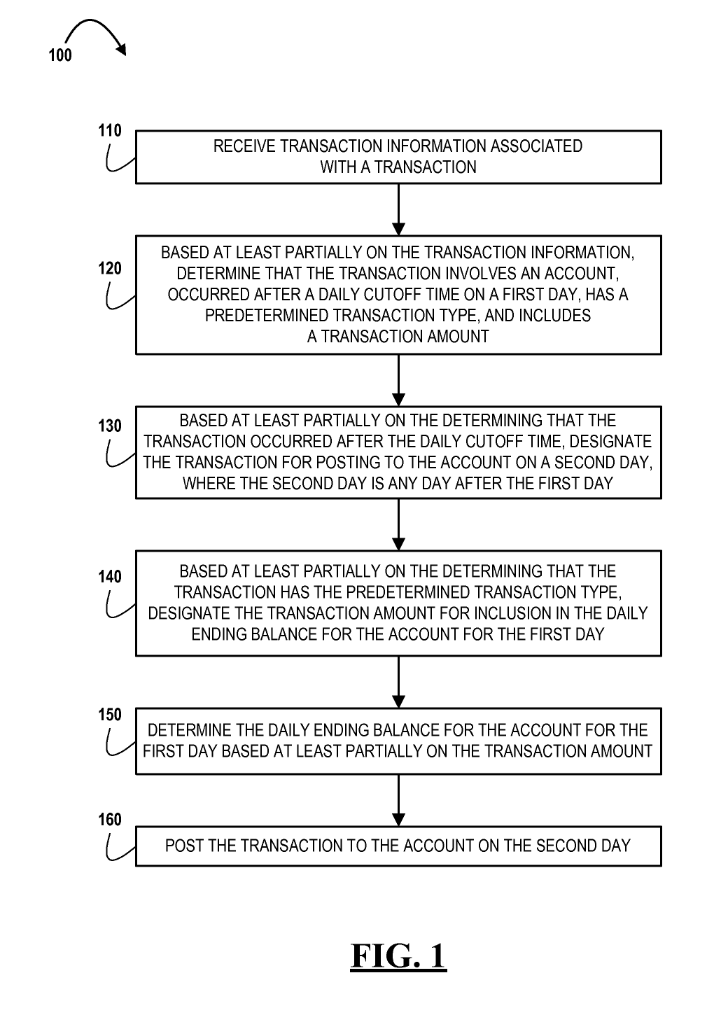

Referring now to FIG. 1, a general process flow 100 for processing a transaction that involves an account and occurred after a daily cutoff time is provided, in accordance with an embodiment of the present invention. In some embodiments, the process flow 100 is performed by an apparatus having hardware and/or software configured to perform one or more portions of the process flow 100. In such embodiments, as represented by block 110, the apparatus is configured to receive transaction information associated with the transaction. Then, as represented by block 120, the apparatus is configured to determine, based at least partially on the transaction information, that the transaction involves the account, occurred after a daily cutoff time on a first day, has a predetermined transaction type, and includes a transaction amount. As represented by block 130, the apparatus is further configured to designate, based at least partially on the determining that the transaction occurred after the daily cutoff time, the transaction for posting to the account on a second day, where the second day is any day after the first day. As represented by block 140, the apparatus is also configured to designate, based at least partially on the determining that the transaction has the predetermined transaction type, the transaction amount for inclusion in the daily ending balance for the account for the first day. As represented by block 150, the apparatus is further configured to determine the daily ending balance for the account for the first day based at least partially on the transaction amount, and, as represented by block 160, the apparatus is also configured to post the transaction to the account on the second day.

For simplicity, the portion of the process flow 100 represented by block 120 is sometimes referred to herein as the “transaction determination,” the portion represented by block 130 is sometimes referred to herein as the “posting designation,” the portion represented by block 140 is sometimes referred to herein as the “inclusion designation,” and the portion represented by block 150 is sometimes referred to herein as the “daily ending balance determination.” In addition, it will be understood that, the term “determine,” in some embodiments, is meant to have its one or more ordinary meanings (i.e., its ordinary dictionary definition(s)), but in other embodiments, “determine” is meant to additionally or alternatively have the one or more ordinary meanings of the following terms: conclude, verify, ascertain, decide, find, discover, learn, calculate, observe, read, and/or the like.

Also, it will be understood that the apparatus configured to perform the process flow 100 and/or any of the apparatuses described and/or contemplated herein can include one or more separate and/or different apparatuses. For example, in some embodiments, one apparatus (e.g., the decisioning apparatus 320, and the like) is configured to perform the portions of the process flow 100 represented by blocks 110-140, and a second apparatus (e.g., the batch processing apparatus 330, and the like) is configured to perform the portions represented by blocks 150 and 160. However, in other embodiments, a single apparatus is configured to perform each and every portion of the process flow 100. In addition, in some embodiments, a first portion of an apparatus is configured to perform one or more portions of the process flow 100, and one or more other portions of the same apparatus are configured to perform the one or more other portions of the process flow 100.

Regarding block 110, the transaction can include any transaction involving an account. Exemplary transactions include, but are not limited to: purchasing, renting, selling, and/or leasing one or more goods and/or services (e.g., merchandise, groceries, tickets, and the like); withdrawing cash; making deposits; making payments to creditors (e.g., paying bills, paying taxes, and the like); sending remittances; transferring funds; loading money onto stored value cards; and/or the like. In addition, the transaction information can be any information that identifies, defines, describes, and/or is otherwise associated with the transaction. Exemplary transaction information includes, but is not limited to, the party(ies) involved in the transaction, the date and/or time of the transaction, the account(s) involved in the transaction, the transaction amount(s) associated with the transaction, the good(s) and/or service(s) involved in the transaction, a description of the transaction (which, itself, can include any transaction information, e.g., the description may describe the transaction status, the goods and/or services involved in the transaction, and the like), and/or the like. In some embodiments, the transaction information additionally or alternatively includes information indicating whether a transaction amount associated with the transaction should be included in the available balance and/or daily ending balance for the account. In some embodiments, the transaction information additionally or alternatively includes information indicating when the transaction should post to the account.

The transaction information can also include any information that identifies, defines, describes, and/or is otherwise associated with the type of the transaction. As understood herein, the transaction type of a transaction may be defined, at least in part, by the one or more goods and/or services involved in the transaction (e.g., withdrawing cash, purchasing groceries, transferring funds, and the like), the one or more parties involved in the transaction (e.g., account holder, bank, teller, merchant, counterparty, and the like), when the transaction occurred (e.g., time of day, day of week, before or after the daily cutoff time, and the like), and/or the like. In some embodiments, the transaction type is defined, at least in part, by the one or more channels through which the transaction is conducted, such as, for example, a point-of-sale (“POS”) device, ATM, teller terminal, electronic banking account (e.g., online banking account, mobile banking account, SMS banking account, and the like), personal computer, mail, kiosk, call center, and/or the like. Additionally or alternatively, in some embodiments, the transaction type is defined, at least in part, by the one or more instruments and/or methods used to conduct the transaction, such as, for example, a debit card, credit card, checkcard, ATM card, paper check, electronic check, wire transfer, cash, online bill pay, automated clearing house (ACH), wireless and/or contactless payment, and/or the like.

The transaction type can also be defined, at least in part, by the status of the transaction, such as, for example, whether the transaction is and/or has been initiated, authorized, pending, held, delayed, posted, cleared, processed, finalized, reconciled, and/or the like. Further, in some embodiments, the transaction type is defined, at least in part, by whether the transaction typically, actually, and/or entirely involves cash, such as, for example, a cash withdrawal, cash deposit, funds transfer, and/or the like (collectively referred to herein as “cash-related transactions” for simplicity). Of course, any given transaction may have more than one transaction type. For example, in accordance with some embodiments, a cash withdrawal transaction conducted at an ATM after a daily cutoff time may be defined as a cash-related transaction, a withdrawal transaction, an ATM transaction, and/or an after-cutoff transaction.

Further regarding block 110, the transaction information can additionally or alternatively identify and/or describe one or more merchant category codes associated with the transaction. As used herein, the phrase “merchant category code” generally refers to a number assigned to a merchant by a financial institution, where the number is used to classify the merchant by the type of goods and/or services the merchant provides. In some embodiments, the merchant category code is a four digit number assigned by a credit card provider (which, in some embodiments, is a bank). A merchant category code may generally refer to the goods and/or services provided by a merchant (e.g., hospital, fast food restaurant, and the like) and/or may specifically identify the name of an individual merchant. In other words, individual industries and/or individual merchants can have their own merchant category codes. In some embodiments, the transaction type of the transaction referred to in block 110 is defined, at least in part, by one or more merchant codes associated with the transaction.

Also regarding block 110, the apparatus having the process flow 100 can be configured to receive the transaction information in any way. For example, in some embodiments, the apparatus is configured to receive an authorization request associated with the transaction, where the authorization request includes the transaction information referred to in block 110. In some embodiments, the apparatus is provided, serviced, operated, controlled, managed, and/or maintained (collectively referred to herein as “maintained” for simplicity) by a financial institution, and the apparatus is configured to approve and/or decline authorization requests for debit transactions, ATM transactions, POS device transactions, and/or one or more other types of transactions that involve one or more accounts maintained by the financial institution. As another example, in some embodiments, the apparatus having the process flow 100 includes a transaction machine (e.g., POS device, ATM, and the like) configured to initiate, perform, complete, and/or otherwise facilitate one or more transactions, and thus receives transaction information when the transaction machine is used to conduct a transaction. As still another example, in some embodiments, the apparatus having the process flow 100 includes a batch processing apparatus (e.g., the batch processing apparatus 330, and the like), and the batch processing apparatus is configured to receive the transaction information referred to in block 110 by receiving a batch job having that transaction information stored therein.

In accordance with some embodiments, the apparatus having the process flow 100 can be configured to receive the transaction information directly or indirectly from the source of the transaction. For example, in some embodiments, where the transaction involves a transaction machine (e.g., ATM, POS device, personal computer, and the like), the apparatus is located remotely from the transaction machine but is operatively connected to the transaction machine via a network. As another example, in some embodiments, where the transaction involves a transaction machine, the apparatus may include the transaction machine. For example, where the transaction involves a cash withdrawal at an ATM, the apparatus configured to perform the process flow 100 is embodied as the ATM.

Regarding block 120, the account involved in the transaction referred to in block 110 can include any number and/or type of account(s). For example, in some embodiments, the account includes a checking account, savings account, money market account, investment account, brokerage account, and/or some other kind of deposit account. In some embodiments, the deposit account includes one or more accounts that can incur a surpassed balance, become discrepant, and/or have unavailable funds. Of course, it will be understood that embodiments of the present invention may also apply to one or more credit accounts, such as a credit card account, line of credit (LOC) account, store credit account, and/or the like. Additionally or alternatively, in some embodiments, the credit account includes one or more accounts that can incur an amount “exceeded credit threshold.” For example, if a credit account has a $5,000 maximum credit threshold and a $5,300 account balance, then it will be understood that the credit account has incurred an exceeded credit threshold amount of $300.

In accordance with some embodiments, the account can have a daily ending balance. As used herein, the phrase “daily ending balance” refers to the available balance for an account at the end of day, which, in some embodiments, is the end of a business day (e.g., 5:00 pm, 11:59 pm, and the like). The phrase “available balance,” as used herein, generally refers to an amount of funds and/or credit in an account that is immediately available (e.g., to an account holder, to cover debit and/or credit transactions, for withdrawal, for making a balance transfer, and the like). Thus, the daily ending balance generally refers to an amount of funds and/or credit in an account that is immediately available at the end of day. The available balance and daily ending balance typically include one or more transaction amounts from one or more transactions involving the account.

In accordance with some embodiments, the available balance and/or the daily ending balance may not include every transaction amount from every transaction involving the account. For example, in some embodiments, the daily ending balance does not include transaction amounts from transactions that occur after a daily cutoff time and do not have a predetermined transaction type. As another example, in some embodiments, the available balance does not include transaction amounts from transactions that are subject to holds. As still another example, in some embodiments, the daily ending balance and the available balance are not based on transactions unknown to the financial institution maintaining the account, such as, for example, where the account is a checking account, the account holder has written a check to a payee, and the payee has not yet deposited the check at the payee's financial institution. The phrase “available balance” is sometimes referred to herein as, and is meant to be synonymous with, “an amount currently available” and/or an “amount available now.”

Referring to block 130, the apparatus having the process flow 100 is configured to designate the transaction for posting to the account on the second day based at least partially on the apparatus determining that the transaction occurred after the daily cutoff time on the first day. In other words, because the transaction occurred after the daily cutoff time on the first day, the transaction should not (and/or will not) post to the account on the first day; instead, the transaction should (and/or will) post to the account on a day after the transaction actually occurred (i.e., the second day). For example, in accordance with some embodiments, if the transaction referred to in block 110 occurs after the daily cutoff time on Monday, then the apparatus having the process flow 100 may designate the transaction for posting to the account on Tuesday (e.g., the day immediately after said Monday, a week and a day after said Monday, and the like). In some embodiments, the apparatus may designate the transaction for posting to the account on Tuesday even if the transaction has a predetermined transaction type.

Of course, it will be understood that the apparatus making the posting designation (represented by block 130) is not the same as the apparatus actually posting the transaction to the account (represented by block 160). For example, in some embodiments, the posting designation refers to the function of determining when the transaction can, will, and/or should post to the account, which is typically based at least partially on when the transaction occurred (e.g., before the daily cutoff time, after the daily cutoff time, and the like) and/or on some other fact and/or rule. Additionally or alternatively, in some embodiments, the posting designation refers to the function of assigning an identifier to the transaction, where the identifier includes information about, for example, when the transaction should post to the account, when the transaction occurred (e.g., after the daily cutoff time, and the like), and/or the like. In still other embodiments, the posting designation refers to the function of “bucketing” and/or otherwise grouping the transaction into a predetermined folder, file, and/or other location related to posting transactions (e.g., a folder entitled “after-cutoff transactions designated for posting today,” and the like). In some embodiments, the posting designation at least partially affects when the transaction actually posts to the account. Said differently, in some embodiments, the apparatus having the process flow 100 is configured to post the transaction to the account based at least partially on the posting designation.

Referring to block 140, the apparatus having the process flow 100 is configured to designate the transaction amount for inclusion in the daily ending balance based at least partially on the apparatus determining that the transaction has the predetermined transaction type. In other words, because the transaction has the predetermined transaction type, the transaction amount should (and/or will) be included in the daily ending balance for the account for the first day. For example, in some embodiments, where the predetermined transaction type is “ATM transactions,” if the transaction referred to in block 110 is performed on Monday using an ATM, then the apparatus having the process flow 100 may designate the ATM transaction amount for inclusion in the daily ending balance for the account for Monday. In some embodiments, the apparatus may designate the ATM transaction amount for inclusion in the daily ending balance for Monday even if the ATM transaction occurred after a daily cutoff time (e.g., the daily cutoff time for ATM transactions, and the like).

Of course, it will be understood that the apparatus making the inclusion designation (represented by block 140) is not the same as the apparatus actually determining the daily ending balance for the account for the first day (represented by block 150). For example, in some embodiments, the inclusion designation refers to the function of determining whether the transaction amount can, will, and/or should be included in the daily ending balance for the account for the first day, which is typically based at least partially on whether the transaction has a predetermined transaction type, and/or on some other fact and/or rule. Additionally or alternatively, in some embodiments, the inclusion designation refers to the function of assigning an identifier to the transaction, where the identifier includes information about, for example, whether the transaction should be included in the daily ending balance for the account for the first day, the type of the transaction, and/or the like. In still other embodiments, the inclusion designation refers to the function of “bucketing” and/or otherwise grouping the transaction into a predetermined folder, file, and/or other location related to determining daily ending balances (e.g., a folder entitled “transaction amounts designated for inclusion in today's daily ending balance,” and the like). In some embodiments, the inclusion designation at least partially affects whether the transaction amount is actually included in the daily ending balance for the account for the first day. Said differently, in some embodiments, the apparatus having the process flow 100 is configured to determine the daily ending balance for the account for the first day based at least partially on the inclusion designation.

Further regarding block 140, in some embodiments, the predetermined transaction type includes cash-related transactions, such that the apparatus having the process flow 100 is configured to determine that a transaction amount from a cash-related transaction should be included in the daily ending balance for the account for the first day. In some of these embodiments, the apparatus is configured to make this determination regardless of whether that transaction occurs before or after the daily cutoff time on the first day. Also, in some embodiments, the predetermined transaction type includes cash-related transactions because, for example, crediting or debiting a cash-related transaction presents a relatively lower risk to a financial institution than, for example, crediting or debiting a transaction involving a check and/or credit. For example, a cash deposit transaction is less likely than a check deposit transaction to result in a returned deposit item (RDI).

Of course, the predetermined transaction type can be different in other embodiments of the present invention. For example, in some embodiments, the predetermined transaction type includes teller transactions, such that the apparatus having the process flow 100 is configured to determine that a transaction amount from a transaction involving a teller should be included in the daily ending balance for the deposit account for the first day. As another example, in some embodiments, the predetermined transaction type includes merchant transactions having one or more predetermined merchant category codes, such that the apparatus having the process flow 100 is configured to determine that a transaction amount from a transaction having the one or more predetermined merchant category codes should be included in the daily ending balance for the account for the first day. In some embodiments, the predetermined transaction type is based at least partially on the status of the transaction, the transaction amount associated with the transaction, a party involved in the transaction, and/or the like. Also, it will be understood that the predetermined transaction type is “predetermined” because it is determined before the apparatus having the process flow 100 performs one or more (or all) portions of the process flow 100 (e.g., before the apparatus receives the transaction information referred to in block 110, before the apparatus makes the inclusion determination represented by block 140, and the like).

Further regarding block 140, the phrase “the daily ending balance for the account for the first day” generally refers to the available balance of the account at the end of the first day, as determined by the apparatus having the process flow 100 (and/or one or more other apparatuses). In some embodiments, the daily ending balance represents the amount a financial institution uses at the end of day to pay transactions involving the account that occurred earlier that day (and/or before a daily cutoff time that day). In addition, in some embodiments, the phrase “the transaction amount is included in the daily ending balance” means that the daily ending balance is based at least partially on the transaction amount and/or the transaction. For example, in some embodiments, the transaction referred to in block 110 is a cash withdrawal transaction, the transaction amount is $100, the daily ending balance for the account is $1,000, and the transaction amount is included in the daily ending balance (i.e., the account balance prior to the transaction was $1,100). However, in some embodiments, if the transaction amount was not included in the daily ending balance, then the daily ending balance may be $1,100.

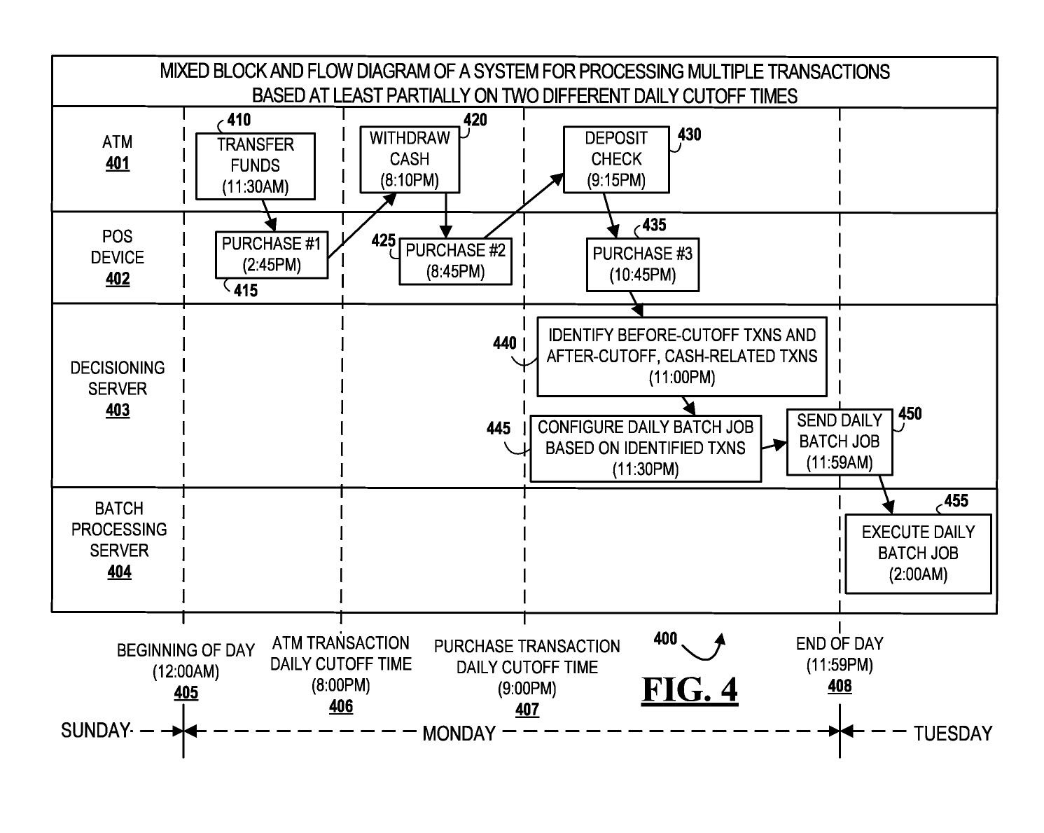

Further regarding blocks 110-140, the apparatus having the process flow 100 can be configured to receive the transaction information and make the transaction determination, posting designation, and inclusion designation as part of a single identification, designation, and/or collection effort. For example, in some embodiments, the apparatus is configured to identify all of the transactions that involve the account, occur after the daily cutoff time on the first day, and have the predetermined transaction type. Thereafter, in such embodiments, the apparatus may be configured to designate those transactions for posting to the account on the second day and/or for inclusion in the daily ending balance for the account for the first day. In other embodiments, the apparatus may be additionally or alternatively configured to collect transaction information associated with those transactions and include that transaction information into a batch job, which is described in more detail later herein. In some embodiments, the apparatus is configured to access an account datastore (e.g., the account datastore 440 shown in FIG. 4, and the like) in order to identify, designate, and/or collect this transaction information.

Referring to block 150, the apparatus is configured to determine the daily ending balance for the account for the first day based at least partially on the transaction amount. Of course, the daily ending balance may be based on other transactions involving the account. For example, in some embodiments, the daily ending balance is based at least partially on one or more other transactions that involve the account, occurred after the daily cutoff time on the first day, and have the predetermined transaction type. Additionally or alternatively, in some embodiments, the daily ending balance is based at least partially on one or more transactions that involve the account and occurred before the daily cutoff time. Also, in some embodiments, the apparatus having the process flow 100 is configured to make the daily ending balance determination as part of executing a daily batch job. Further, in some embodiments, the apparatus is configured to make the daily ending balance determination based at least partially on the inclusion designation.

Referring to block 160, the apparatus is also configured to post the transaction to the account on the second day. In some embodiments, the apparatus is configured to post the transaction to the account based at least partially on the posting designation. Also, as with the daily ending balance determination, it will be understood that the apparatus having the process flow 100 can be configured to post the transaction to the account as part of executing a daily batch job.

As used herein, the phrase “post the transaction to the account” generally refers to the function of storing transaction information associated with the transaction (e.g., transaction description, transaction type, date of transaction, transaction amount, and the like) in a computer-readable medium, where the computer-readable medium includes information associated with the account (e.g., routing number and/or account number, account description, account type, and the like). For example, in some embodiments, the transaction referred to in block 110 posts to the account when a description of the transaction and/or the transaction amount is stored and/or displayed in an electronic and/or physical transaction ledger associated with the account. In some embodiments, this transaction ledger is shown in an electronic banking account (e.g., online banking account, mobile banking account, and the like) associated with the account and/or that is accessible to a holder of the account. However, in other embodiments, this transaction ledger is accessible only to a financial institution that maintains the account and is not shown in the electronic banking account and/or accessible to the account holder.

In some embodiments, the transaction posts to the account when the transaction is “hard-posted” to the account. In some embodiments, this means that the transaction is cleared by a financial institution that maintains the account. As used herein, it will be understood that cleared transactions are not necessarily final (i.e., “finalized”) because there may be some circumstances in which such transactions may be reversed. Additionally or alternatively, a transaction hard-posts to an account when funds are actually moved into or out of the account as a result of the transaction. Similarly, in some embodiments, a transaction hard-posts to an account when credit is actually incremented to or decremented from the account as a result of the transaction. In some embodiments, the transaction additionally or alternatively hard-posts to the account when the transaction is assigned a particular posting date by a financial institution that maintains the account. For example, in some embodiments, the transaction referred to in block 110 posts to the account when the apparatus having the process flow 100 electronically assigns to the transaction the posting date of the second day.

In other embodiments, the transaction posts to the account when the transaction is “soft-posted” and/or “memo-posted” to the account. In some embodiments, this means that the transaction is posted to an electronic banking account associated with the account referred to in block 120 (e.g., the transaction is posted to a transaction ledger displayed in the electronic banking account, and the like). The phrase “electronic banking account,” as used herein, generally refers to an electronic account that is accessible to an account holder via a network (e.g., the Internet, and the like) and that includes information associated with a traditional account (e.g., a checking account, savings account, credit card account, the account referred to in block 120, and the like). It will be understood that the electronic banking account can include one or more online banking accounts, mobile banking accounts, SMS banking accounts, and/or the like. In some embodiments, the account holder can use the electronic banking account to check the available balance and/or daily ending balance, view transaction information, pay bills, transfer funds, order checks, and/or perform one or more other tasks involving their traditional account. In some embodiments, the electronic banking account is embodied as and/or includes one or more web pages, HTML pages, Internet pages, intranet pages, dashboard application pages, and/or the like. In some embodiments, the electronic banking account is accessible using a personal computer, mobile phone, ATM, gaming device, and/or the like. In some embodiments, the electronic banking account holder is identified and/or authenticated before being provided access to his or her electronic banking account. For example, in some embodiments, the account holder is required to present and/or provide (e.g., via a login page, and the like) one or more usernames/passwords, personal identification numbers (“PINs”), biometric information, secret information, answers to challenge questions, and/or one or more other credentials to the financial institution that maintains the electronic banking account, so that the financial institution can verify that the account holder is who he says he is prior to the financial institution allowing the account holder to access the electronic banking account. In some embodiments, the electronic banking account is maintained by the same financial institution that maintains the account referred to in block 120 and/or the apparatus having the process flow 100.

Further regarding block 160, in some embodiments, the phrase “post the transaction to the account on the second day” means that the transaction is actually posted to the account on the second day (i.e., the “soft,” “memo,” and/or “hard” posting actually occurs on the second day). In other embodiments, the phrase additionally or alternatively means that the transaction is assigned a posting date of the second day, whether the transaction actually posts to the account on the second day or not. For example, in some embodiments, the apparatus having the process flow 100 may assign to the transaction referred to in block 110 a posting date of the second day, even though the transaction is not actually posted to the account until a third day (i.e., a day after the second day and the first day). In other embodiments, as mentioned previously, the transaction posts to the account when the transaction is assigned the posting date (which may or may not occur on the second day).

In some embodiments, the apparatus having the process flow 100 can be configured to perform any one or more portions of the process flow 100 represented by blocks 110-160 upon or after one or more triggering events, which, in some embodiments, is one or more of the other portions of the process flow 100. As used herein, it will be understood that a “triggering event” refers to an event that automatically triggers the execution, performance, and/or implementation of a triggered action, either immediately, nearly immediately (i.e., within minutes), or sometime after the occurrence of the triggering event. For example, in some embodiments, the apparatus is configured such that the apparatus receiving the transaction information (the triggering event) automatically and immediately triggers the apparatus to determine, based at least partially on the transaction information, that the transaction involves the account, occurred after the daily cutoff time on the first day, has the predetermined transaction type, and includes the transaction amount (the triggered action). In some embodiments, the apparatus is additionally or alternatively configured to automatically make the posting designation (triggered action) simultaneous with or sometime after (e.g., minutes after, hours after, and the like) determining that the transaction occurred after the daily cutoff time (triggering event).

In some embodiments, a predetermined time and/or the passage of a predetermined period of time may serve to trigger one or more of the portions represented by blocks 110-160. Also, in some embodiments, the apparatus is configured to automatically perform one or more (or all) of the portions of the process flow 100 represented by blocks 110-160. In other embodiments, one or more (or all) of the portions of the process flow 100 represented by blocks 110-160 require and/or involve at least some human intervention. In addition to the process flow 100, any of the embodiments described and/or contemplated herein can involve one or more triggering events, triggered actions, automatic actions, apparatus actions, and/or human actions. Further, it will be understood that one or more portions of the process flow 100 can occur at any time with respect to the status of the transaction referred to in block 110. For example, in some embodiments, the apparatus is configured to perform one or more portions of the process flow 100 after the transaction is initiated and/or after the transaction is authorized but before the transaction is finalized.

It will also be understood that the apparatus having the process flow 100 can be configured to perform any one or more portions of any embodiment described and/or contemplated herein, including, for example, any one or more portions of the process flows 200 and/or 400 described later herein. In addition, the number, order, and/or content of the portions of the process flow 100 are exemplary and may vary. Indeed, the process flow 100, like all of the other process flows described herein, can include one or more additional and/or alternative process flow portions, and the apparatus configured to perform the process flow 100 can be configured to perform one or more additional and/or alternative functions.

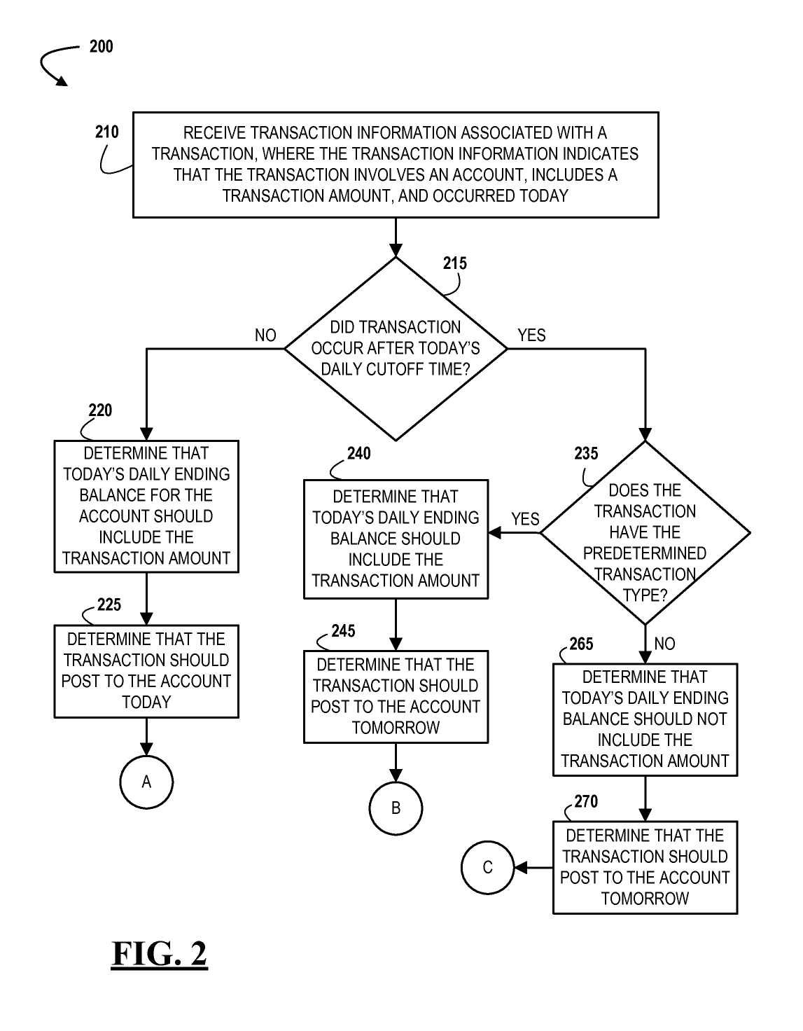

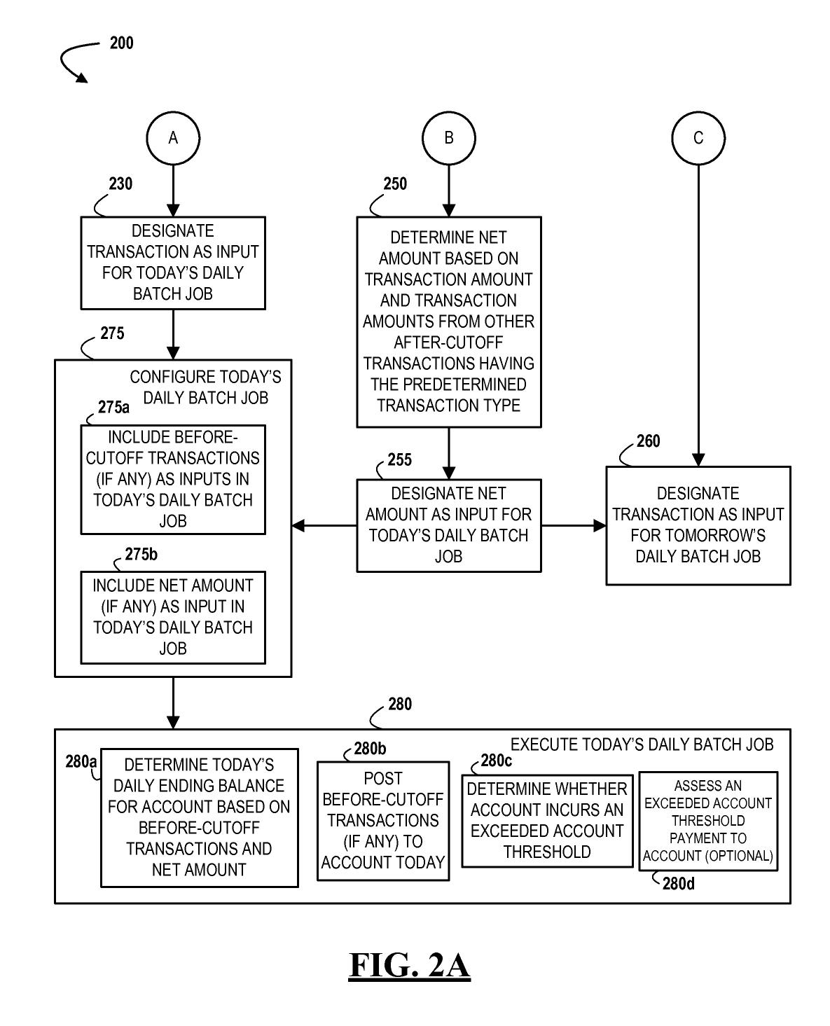

Referring now to FIGS. 2-2A, a general process flow 200 is provided for processing one or more transactions based at least partially on a daily cutoff time, in accordance with an embodiment of the present invention. In some embodiments, the process flow 200 represents a more-specific example of the process flow 100 described in connection with FIG. 1. Additionally, in some embodiments, the process flow 200 is performed by an apparatus having hardware and/or software configured to perform one or more portions of the process flow 200. In such embodiments, as represented by block 210, the apparatus is configured to receive transaction information associated with a transaction, where the transaction information indicates that the transaction involves an account, includes a transaction amount, and occurred today (i.e., the transaction occurred on the same day that the transaction information was received by the apparatus having the process flow 200, and the like). After receiving the transaction information, the apparatus is configured to determine whether the transaction occurred after today's daily cutoff time, as represented by block 215. If the transaction did not, then the apparatus is configured to determine that today's daily ending balance for the account should include the transaction amount, as represented by block 220. In addition, as represented by block 225, the apparatus is configured to determine that the transaction should post to the account today. Following the process flow 200 from block 225 to block A (shown in FIG. 2) and then from block A to block 230 (shown in FIG. 2A), the apparatus is also configured to designate the transaction as input for today's daily batch job, as represented by block 230. For example, in some embodiments, the apparatus is configured to assign an “input” identifier to the transaction information associated with the transaction.

Referring again to block 215, if the apparatus having the process flow 200 determines that the transaction referred to in block 210 occurred after today's daily cutoff time, then the apparatus is configured to determine whether the transaction has a predetermined transaction type (e.g., a cash-related transaction, an ATM transaction, a transaction having a predetermined merchant category code, and the like), as represented by block 235. (In accordance with some embodiments, the predetermined transaction type can include two or more predetermined transaction types.) If the apparatus determines that the transaction has the predetermined transaction type, then the apparatus is configured to determine that today's daily ending balance for the account should include the transaction amount, as represented by the block 240. In addition, the apparatus is also configured to determine that the transaction should post to the account tomorrow (and/or should not post to the account today), as represented by block 245. In some embodiments, the apparatus is configured to make this posting determination based at least partially on the determination that the transaction occurred after today's daily cutoff time.

In some embodiments, the term “tomorrow,” as used in block 245 and elsewhere in FIGS. 2-2A, literally means tomorrow, i.e., the day immediately after the day “today” referred to in FIGS. 2-2A. However, in other embodiments, the term “tomorrow” does not literally mean tomorrow but rather some other day after “today,” such as, for example, two days after “today,” a week after “today,” a month after “today,” or the like. In some embodiments, the apparatus having the process flow 200 is configured to determine what “tomorrow” means (i.e., determine when the transaction should post to the account) based at least partially on one or more rules, which, in some embodiments, depend on the type(s) of the transaction. Still referring to block 245, in some embodiments where the transaction involves a merchant, the apparatus having the process flow 200 is configured to determine that the transaction should post to the account on the day the final transaction amount is received from the merchant. In other words, in such embodiments, the term “tomorrow” means the day the final transaction amount is received from the merchant, which may be any day after “today.”

Following the process flow 200 from block 245 to block B (shown in FIG. 2) and then from block B to block 250 (shown in FIG. 2A), the apparatus is also configured to determine a net amount that is based at least partially on the transaction amount for the transaction referred to in block 210. In this example embodiment, the net amount is also based on transaction amounts from other transactions involving the account that occurred after today's daily cutoff time and have the predetermined transaction type. Accordingly, in some embodiments, the net amount represents how the daily ending balance for the deposit account should be adjusted based on the transactions involving the account that occurred after the daily cutoff time and have the predetermined transaction type.

In some embodiments, the net amount referred to in block 250 equals the sum of the transaction amount referred to in block 210 plus one or more other transaction amounts, where those one or more other transaction amounts are associated with one or more transactions that involve the account, occurred after today's daily cutoff time, and have the predetermined transaction type. It will be understood that the net amount may be positive or negative. For example, in some embodiments, where two transactions having the predetermined transaction type occurred after today's daily cutoff time in addition to the transaction referred to in block 210, and where the first transaction is a deposit of $100, the second transaction is a purchase of $200, and the third transaction is a funds transfer of $400 out of the account, then the apparatus having the process flow 200 may determine that the net amount is −$500 (i.e., $100−$200−$400=−$500). Also, it will be understood that if no other transactions involving the account and having the predetermined transaction type occurred today, then the net amount may be the transaction amount referred to in block 210.

In addition, as represented by block 255, the apparatus is configured to designate the net amount as input for today's daily batch job. In this example embodiment, the apparatus is further configured to designate the transaction as input for tomorrow's daily batch job, as represented by block 260. In some embodiments, the apparatus is configured to make this input designation based at least partially on the posting determination represented by block 245 (i.e., that the transaction should post to the account tomorrow).

Referring again to block 235, if the apparatus having the process flow 200 determines that the transaction referred to in block 210 does not have the predetermined transaction type, then the apparatus is configured to determine that today's daily ending balance should not include the transaction amount, as represented by block 265. In some embodiments, this additionally or alternatively includes determining that tomorrow's daily ending balance for the account should include the transaction amount. In addition, the apparatus is configured to determine that the transaction should post to the account tomorrow (and/or should not post to the account today), as represented by block 270. In some embodiments, the apparatus is configured to make this posting determination based at least partially on the determination that the transaction occurred after today's daily cutoff time. Following the process flow 200 from block 270 to block C (shown in FIG. 2) and then from block C to block 260 (shown in FIG. 2A), the apparatus is also configured to designate the transaction as input for tomorrow's daily batch job, as represented by block 260. In some embodiments, the apparatus is configured to make this input determination based at least partially on the posting determination represented by block 270 (i.e., that the transaction should post to the account tomorrow).

Referring now to block 275, the apparatus having the process flow 200 is also configured to configure today's daily batch job for processing. Specifically, as represented by blocks 275a, the apparatus is configured to include the before-cutoff transactions that involve the account (if any) in the batch job. For example, in some embodiments, the apparatus is configured to include the transaction amount, transaction description, transaction type, and/or any other transaction information associated with the before-cutoff transactions in the batch job. Thus, if the transaction referred to in block 210 occurred before today's daily cutoff time, then the apparatus includes that transaction as an input in today's daily batch job, along with any other before-cutoff transactions that occurred today and involve the account. Of course, in some embodiments, if no before-cutoff transactions involving the account occurred today, then the apparatus having the process flow 200 may be configured not to include any before-cutoff transactions in today's daily batch job. In some embodiments, the apparatus is configured to collect transaction information from transactions that have been designated as inputs for today's daily batch job and/or that have been designated to post to the account today.

As represented by block 275b, the apparatus is also configured to include the net amount (if any) in today's daily batch job, where the net amount is based at least partially on the transactions involving the account that occurred after today's daily cutoff time and have the predetermined transaction type. Thus, if the transaction referred to in block 210 occurred after today's daily cutoff time and has the predetermined transaction type, then the apparatus includes a net amount as an input in today's daily batch job, where the net amount is based at least partially on the transaction amount from that transaction, as well as the transaction amounts from other after-cutoff transactions having the predetermined transaction type. Of course, in some embodiments, if no after-cutoff transactions having the predetermined transaction type and involving the account occurred today, then the apparatus having the process flow 200 may be configured not to include a net amount in today's daily batch job.

Also, it will be understood that the apparatus having the process flow 200 can be configured to assemble, organize, format, and/or otherwise configure the batch job for processing in any way. In some embodiments, the inputs (e.g., the before-cutoff transactions, the net amount, and the like) are selected through scripts and/or command-line parameters. Also, it will be understood that the apparatus having the process flow 200 can be configured to configure the batch job at any time. For example, in some embodiments, the apparatus is configured to input transaction information into the batch job periodically and/or incrementally throughout the day. In other embodiments, the apparatus is configured to input transaction information into the batch job near and/or at the end of day and/or just before executing the batch job.

After configuring the batch job for processing, the apparatus having the process flow 200 is configured to execute the batch job, as represented by block 280. More specifically, in this example embodiment, the apparatus is configured to determine today's daily ending balance for the account based at least partially on the before-cutoff transactions and the net amount, as represented by block 280a. In addition, the apparatus is configured to post the before-cutoff transactions (if any) to the account, as represented by block 280b. Further, the apparatus is configured to determine whether the account incurs an exceeded account threshold (e.g., surpassed balance, exceeded credit threshold amount, unavailable funds, unsuccessfully clears a check, and the like) based at least partially on today's daily ending balance, as represented by block 280c. In addition, the apparatus is configured to assess an exceeded account threshold payment to the account based at least partially on whether the account incurs an exceeded account threshold, as represented by block 280d. In some embodiments, the apparatus is configured to perform the actions represented by blocks 280a-280d in the particular order shown, but in other embodiments, the apparatus is configured to perform these actions in a different order.

In addition to the exemplary actions shown in block 280, the apparatus having the process flow 200 can be configured to perform one or more other actions as a result of executing the batch job. For example, in some embodiments, the apparatus is configured to transfer funds into or out the account (and/or increment credit to or decrement credit from the account) as a result of executing the batch job. In some embodiments, the funds and/or credit are moved based at least partially on the transaction information included in the batch job and/or on the posting the transactions to the account. As another example, where performing the transaction would result in the account incurring an exceeded account threshold, the apparatus can be configured to determine whether to pay the exceeded account threshold amount. For example, where the transaction involves a check that, if paid, would cause the account to incur a surpassed balance, the apparatus having the process flow 200 can be configured to make “pay” and/or “no pay” decisions (i.e., determine whether to pay the check or return the check to the depositor). If the apparatus decides to pay the check, the apparatus may be configured to assess the account a surpassed balance payment based at least partially on making the “pay” decision and/or actually paying the check. Additionally or alternatively, if the apparatus decides to return the check, the apparatus may be configured to assess the account an unavailable funds payment based at least partially on making the “no pay” decision. In some embodiments, the apparatus having the process flow 200 is configured to make a “pay” or “no pay” decision for each transaction included in and/or represented in the batch job.

Accordingly, in this example embodiment, if the transaction referred to in block 210 occurs before today's daily cutoff time, then the transaction amount from that transaction will be represented in today's daily batch job and in today's daily ending balance, and the transaction will be posted to the account today. If the transaction referred to in block 210 occurs after today's daily cutoff time and does not have the predetermined transaction type, then the transaction amount from that transaction will not be represented in today's daily batch job or in today's daily ending balance, and the transaction will not be posted to the account today; instead, the transaction amount will be represented in tomorrow's daily ending balance and the transaction will be posted to the account tomorrow (i.e., a day after “today”). On the other hand, if the transaction referred to in block 210 occurred after today's daily cutoff time and has the predetermined transaction type, then the transaction amount from that transaction will be represented in today's daily batch job (e.g., via the net amount referred to in blocks 250, 255, and 275b, and the like) and in today's daily ending balance; however, because the transaction occurred after today's daily cutoff time, the transaction will post to the account tomorrow.

Thus, it will be understood that the process flow 200 describes a method for using a net amount to represent at least some after-cutoff transactions (i.e., those having the predetermined transaction type) in a daily ending balance for an account for a first day (e.g., “today” in the example embodiment of FIG. 2, and the like), even though those after-cutoff transactions will not post to the account until a second day, which is any day after the first day (e.g., “tomorrow” in the example embodiment of FIG. 2, and the like). In so doing, the daily ending balance for the account for the first day more accurately reflects the transaction history for the account on the first day. As such, the process flow 200 enables a financial institution to achieve a batch processing environment that more closely resembles a real-time transaction processing environment.

In addition, it will be understood that the net amount referred to in block 275b can be a relatively small input (e.g., small file size, and the like) compared to the transaction information associated with the before-cutoff transactions referred to in block 275a. Because the net amount is relatively small and thus does not take very long to include in the batch job, the net amount may be added to the batch job well after the daily cutoff time and/or just before the batch job is executed. As such, the net amount may represent transaction amounts from transactions that occurred well after the daily cutoff time and/or just before the batch job is executed. If more transactions can be represented by the net amount, then the net amount enables a financial institution to achieve a batch processing environment that more closely resembles a real-time transaction processing environment.

Still further, the use of the net amount enables a financial institution to “virtually move” the daily cutoff time for some after-cutoff transactions (i.e., those having the predetermined transaction type) to a later time on the first day, even though the daily cutoff times already in existence can remain the same for all other transactions. For example, the daily cutoff time for cash-related transactions performed at an ATM can be moved to 11:59 pm on the first day, even though the daily cutoff time for all other ATM transactions can remain at 8:00 pm. This change may improve customer satisfaction because, in this example, the customer-perceived daily cutoff time for cash-related ATM transactions will now be near midnight, instead of at some earlier time (i.e., 8:00 pm) on the first day. By more closely aligning the customer-perceived daily cutoff time with the end of day, the process flow 200 may enable a financial institution to more closely align daily cutoff times with customer perceptions of fairness, all without substantially disrupting the existing batch processing environment needed to process financial transactions on a daily basis.

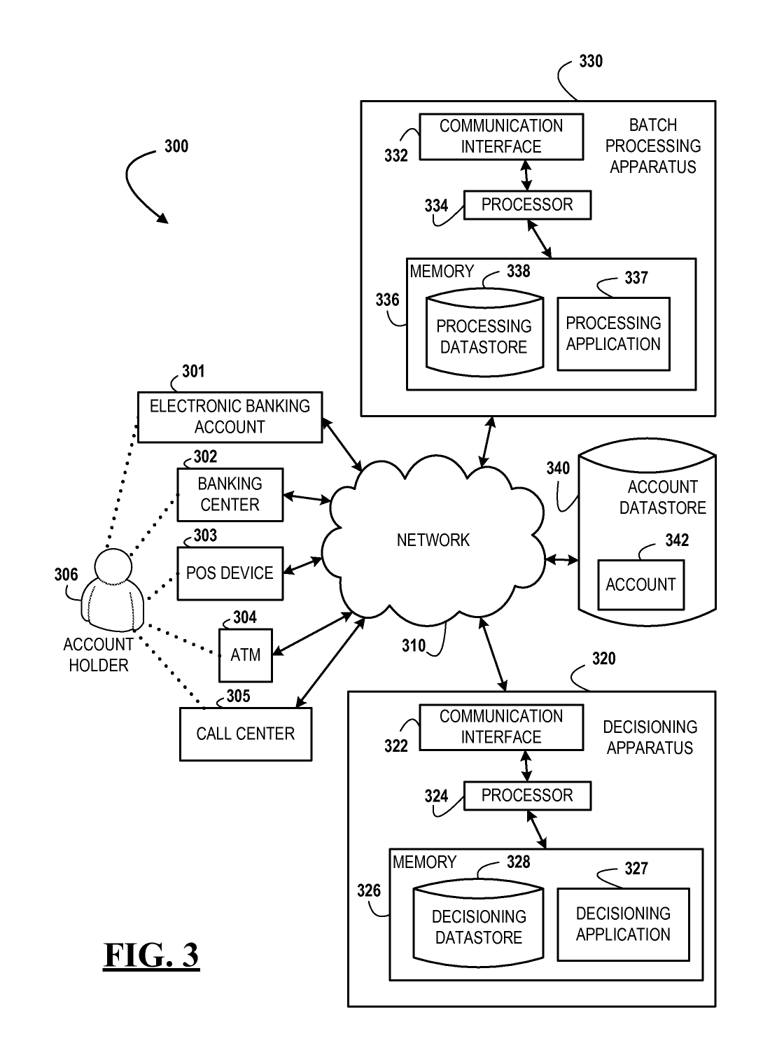

It will be understood that, in some embodiments, the apparatus having the process flow 200 includes a decisioning apparatus (e.g., the decisioning apparatus 320 illustrated in FIG. 3, and the like) and a batch processing apparatus (e.g., the batch processing apparatus 330, and the like). In such embodiments, the decisioning apparatus may be located remotely from, but operatively connected to, the batch processing apparatus. Also in such embodiments, the decisioning apparatus may be configured to perform the portions of the process flow represented by blocks 210-275b, and the batch processing apparatus may be configured to perform the portions of the process flow represented by blocks 280a-280d. However, in other embodiments, the process flow 200 is performed by a single apparatus. In some of these embodiments, the apparatus having the process flow 200 is also a batch processing apparatus.

Also, it will be understood that, even though the portions of the process flow represented by blocks 210-270 describe the processing of a single transaction involving the account, the same portions of the process flow 200 can be used to process two or more (or all) of the transactions involving the account that occurred today. As such, today's daily cutoff time referred to in block 215 can represent one or more different daily cutoff times. For example, a holder of the deposit account may have engaged in two transactions today, where the first transaction occurred at a banking center and the second transaction occurred at an ATM. In such an example, when processing the first transaction according to the process flow 200, the daily cutoff time referred to in block 215 may represent today's daily cutoff time for transactions performed at banking centers and/or at that particular banking center. However, when processing the second transaction according to the process flow 200, the daily cutoff time may represent today's daily cutoff time for transactions performed at ATMs and/at that particular ATM.

In addition, the apparatus having the process flow 200 can be configured to perform the portions of the process flow represented by blocks 210-275 in real time, in substantially real time, at any time, at one or more predetermined times, and/or at one or more different times. For example, in some embodiments, the apparatus having the process flow 200 is configured to decision each and every transaction involving the account that occurred today, in accordance with the portions of the process flow represented by blocks 210-270, just before configuring and/or executing today's daily batch job. In other embodiments, the apparatus having the process flow 200 is configured to decision the transactions after they are initiated, authorized, and/or performed. For example, in some embodiments, the apparatus having the process flow 200 is also configured to approve and/or decline authorization requests for transactions involving accounts maintained by one or more financial institutions. In such embodiments, the apparatus can be configured to decision the transactions associated with those authorization requests, in accordance with the portions of the process flow represented by blocks 210-270, immediately after processing those authorization requests.

Also, although not shown, it will be understood that the apparatus having the process flow 200 can be configured to include inputs into today's daily batch job that are associated with one or more other accounts in addition to the account referred to in block 210. For example, in some embodiments, the apparatus having the process flow 200 is a decisioning server maintained by a bank that configures the batch job for processing by including inputs associated with thousands or millions of accounts maintained by the bank. Also, in some embodiments, the daily batch job referred to in block 275 may include yesterday's after-cutoff transactions and/or the apparatus may execute today's daily batch job to post yesterday's after-cutoff transactions to the account.

Of course, the embodiment illustrated in FIG. 2 is merely exemplary and other embodiments may vary without departing from the scope and spirit of the present invention. For example, in some alternative embodiments, the apparatus does not distinguish between after-cutoff transactions that have the predetermined transaction type and those that do not; instead, the apparatus is configured to determine the net amount referred to in block 250 based on all of the transactions involving the account that occurred after today's daily cutoff time. Also, the apparatus may be configured to perform any of the portions of the process flow 200 represented by blocks 210-280d upon or after one or more triggering events, which, in some embodiments, is the performance of one or more of the other portions of the process flow 200.

Referring now to FIG. 3, a system 300 for processing one or more transactions based at least partially on one or more daily cutoff times is provided, in accordance with an embodiment of the present invention. As illustrated, the exemplary system 300 includes a network 310, a decisioning apparatus 320, a batch processing apparatus 330, and an account datastore 340. The account datastore 340 stores information associated with an account 342 therein, and the account 342 is held by an account holder 306. FIG. 3 also illustrates that the system 300 includes various exemplary channels through which the account holder 306 can conduct transactions involving the account 342, including electronic banking account 301, a banking center 302, a POS device 303, an ATM 304, and a call center 305. In some embodiments, the electronic banking account 301, the banking center 302, the ATM 304, the call center 305, the decisioning apparatus 320, the batch processing apparatus 330, and the account datastore 340 are each maintained by a single financial institution (not shown). In addition, in some embodiments, the POS device 303 is maintained by a merchant that is not the financial institution. Also, in some embodiments, the account holder 306 is a customer of the financial institution, and the account 342 is associated with the electronic banking account 301.

As shown in FIG. 3, the decisioning apparatus 320, the batch processing apparatus 330, the account datastore 340, and the channels 301-305 are each operatively connected to the network 310, which may include one or more separate networks. Also, the network 310 may include one or more interbank networks, telephone networks, telecommunication networks, local area networks (LANs), wide area networks (WANs), and/or global area networks (GANs) (e.g., the Internet, and the like). In accordance with some embodiments, the network 310 may be secure and/or unsecure and may also include wireless and/or wireline technology.

The decisioning apparatus 320 can include any apparatus described and/or contemplated herein. In addition, the decisioning apparatus 320 can initiate, execute, complete, and/or otherwise facilitate any one or more portions of any embodiment described and/or contemplated herein. In some embodiments, the decisioning apparatus 320 includes one or more servers, engines, modules, mainframe computers, personal computers, front end systems, back end systems, network devices, and/or the like. As illustrated in FIG. 3, the decisioning apparatus 320 includes a communication interface 322, a processor 324, and a memory 326 having a decisioning application 327 and decisioning datastore 328 stored therein. As shown, the processor 324 is operatively connected to the communication interface 322 and the memory 326.

Each communication interface described herein, including the communication interface 322, generally includes hardware and/or software that enable a portion of the system 300, such as the decisioning apparatus 320, to send, receive, and/or otherwise communicate information to and/or from one or more other portions of the system 300. For example, the communication interface 322 of the decisioning apparatus 320 may include a modem, network interface controller (NIC), network adapter, network interface card, and/or some other electronic communication device that operatively connects the decisioning apparatus 320 with another portion of the system 300.

Each processor described herein, including the processor 324, generally includes circuitry for implementing the audio, visual, and/or logic functions of that portion of the system 300. For example, the processor may include a digital signal processor device, a microprocessor device, and/or various analog-to-digital converters, digital-to-analog converters, and/or other support circuits. Control and signal processing functions of the apparatus in which the processor resides may be allocated between those one or more devices according to their respective capabilities. The processor may also include functionality to operate one or more software programs based at least partially on computer-executable program code portions thereof, which may be stored, for example, in a memory device, such as in the decisioning application 327 of the memory 326.

Each memory device described herein, including the memory 326 for storing the decisioning application 327 and other information, may include any computer-readable medium. For example, the memory may include volatile memory, such as volatile random access memory (RAM) having a cache area for the temporary storage of data. Memory may also include non-volatile memory, which may be embedded and/or removable. The non-volatile memory may additionally or alternatively include an EEPROM, flash memory, and/or the like. The memory may store any one or more portions of information used by the apparatus in which it resides to implement the one or more functions of that apparatus. The memory may be non-transitory or transitory.

As shown in FIG. 3, the memory 326 includes the decisioning application 327. The decisioning application 327 may instruct and/or cause the processor 324 (and/or the decisioning apparatus 320) to execute any one or more of the functions described herein as being performed by “an apparatus,” by the decisioning apparatus 320, and/or by the decisioning application 327. Additionally or alternatively, the decisioning application 327 can be operable to initiate, execute, complete, and/or otherwise facilitate any one or more portions of any embodiment described and/or contemplated herein, such as, for example, any one or more portions of the process flows 100, 200, and/or 400 described herein.

For example, in some embodiments, the decisioning application 327 is executable to receive transaction information associated with a transaction. As another example, in some embodiments, the decisioning application 327 is executable to determine, based at least partially on transaction information, that a transaction involves an account (e.g., the account 342, and the like), has a predetermined transaction type, and/or occurred after, on, or before a daily cutoff time. In some embodiments, the decisioning application 327 is executable to designate a transaction for posting to an account on a first day, second day, and the like For example, in some embodiments, the decisioning apparatus 320 is executable to determine when and/or whether a transaction should post to an account. In other embodiments, the decisioning application 327 is additionally or alternatively executable to designate a transaction amount from a transaction for inclusion in a daily ending balance for an account for a first day, second day, and the like. For example, in some embodiments, the decisioning application 327 is executable to determine whether a transaction amount should or should not be included in a daily ending balance for an account for a particular day.

In some embodiments, the decisioning application 327 is executable to configure a daily batch job for processing and/or send that daily batch job to a batch processing apparatus (e.g., the batch processing apparatus 330, and the like). For example, in some embodiments, the decisioning application 327 is executable to include, assemble, organize, and/or format any amount and/or kind of input data into a batch job, such as, for example, one or more transaction amounts, transaction descriptions, transaction types, and/or the like. In some embodiments, the decisioning application 327 is executable to include before-cutoff transactions and/or a net amount as inputs in a daily batch job. In some embodiments, the decisioning apparatus 320 causes the processor 324 to collect information from the account datastore 340 (e.g., information associated with the account 342, and the like) for the purpose of configuring a batch job. In some embodiments, the decisioning application 327 is executable to access, communicate with, navigate, control, configure, and/or use the batch processing apparatus 330, the processing application 337, the account datastore 340, and/or one or more other portions of the system 300.

The decisioning application 327 can include one or more computer-executable program code portions for instructing and/or causing the processor 324 to execute one or more of the functions of the decisioning application 327 and/or of the decisioning apparatus 320 described and/or contemplated herein. In some embodiments, the decisioning application 327 includes and/or uses one or more network and/or system communication protocols. Also, in some embodiments, the decisioning apparatus 320 includes and/or communicates with an authorization apparatus (not shown), such that the decisioning application 327 is executable to receive authorization requests associated with transactions and then authorize or deny those authorization requests. In some embodiments, the authorization requests are sent from and/or are otherwise associated with one or more of the channels 301-305, such as, for example, where the account holder 306 uses the account 342 to engage in a transaction at one or more of the channels 301-305.

FIG. 3 also shows a batch processing apparatus 330, which may include any apparatus described and/or contemplated herein. In addition, the batch processing apparatus 330 can initiate, execute, complete, and/or otherwise facilitate any one or more portions of any embodiment described and/or contemplated herein. In some embodiments, the batch processing apparatus 330 includes one or more servers, engines, modules, mainframe computers, personal computers, front end systems, back end systems, network devices, and/or the like. As illustrated in FIG. 3, the batch processing apparatus 330 includes a communication interface 332, a processor 334, and a memory 336, which includes a processing application 337 and a processing datastore 338 stored therein. As shown, the communication interface 332 is operatively connected to the processor 334, which is operatively connected to the memory 336.

The processing application 337 may instruct and/or cause the processor 334 (and/or the batch processing apparatus 330) to execute any one or more of the functions described herein as being performed by “an apparatus,” by the batch processing apparatus 330, and/or by the processing application 337. The processing application 337 can be operable to initiate, execute, complete, and/or facilitate any one or more portions of any embodiment described and/or contemplated herein, such as, for example, any one or more portions of the process flows 100, 200, and/or 400 described herein.

For example, in some embodiments, the processing application 337 is executable to receive and/or execute a batch job. Specifically, in some embodiments, the processing application 337 is executable to post (e.g., “hard” post, “soft” post, “memo” post, and the like) a transaction to an account (e.g., the account 342, an electronic banking account associated with the account 342, and the like). In addition, in some embodiments, the processing application 337 is executable to determine a daily ending balance for an account. As yet another example, in some embodiments, the processing application 337 is executable to determine whether an account incurs an exceeded account threshold and/or assess an exceeded account threshold payment to an account. As another example, in some embodiments, the processing application 337 is executable to render and/or paint one or more browser pages of an electronic banking account. As yet another example, in some embodiments, the processing application 337 is executable to transfer funds from an account (e.g., the account 342, and the like) maintained by a first financial institution to a second account maintained by a second financial institution.

In some embodiments, the processing application 337 is executable to enable the batch processing apparatus 330 to communicate with one or more other portions of the system 300, such as, for example, the processing datastore 338, the account datastore 340, the decisioning apparatus 320, and/or vice versa. In addition, in some embodiments, the processing application 337 is executable to initiate, authorize, make pending, facilitate, hold, delay, post, clear, finalize, and/or reconcile one or more transactions. In some embodiments, the processing application 337 includes one or more computer-executable program code portions for causing and/or instructing the processor 334 to execute one or more of the functions of the processing application 337 and/or the batch processing apparatus 330 that are described and/or contemplated herein. In some embodiments, the processing application 337 includes and/or uses one or more network and/or system communication protocols.

In addition to the processing application 337, the memory 336 also includes the processing datastore 338. It will be understood that the processing datastore 338, the decisioning datastore 328, and the account datastore 340 can be configured to store any type and/or amount of information. For example, in some embodiments, the processing datastore 338 includes information associated with executing batch jobs, determining daily ending balances, posting transactions to accounts, and assessing exceeded account threshold payments. As another example, in some embodiments, the decisioning datastore 328 includes one or more rules for determining when transactions should post to accounts and/or one or more rules for determining which transaction amounts should be included in a daily ending balance and which transaction amounts should not. As still another example, in some embodiments, the transaction datastore 340 includes information associated with transactions (e.g., transaction information, and the like), deposit and/or credit accounts, electronic banking accounts, daily ending balances, available balances, merchant category codes, and/or the like.

Each of the processing datastore 338, the decisioning datastore 328, and the transaction datastore 340 may include any one or more storage devices, including, but not limited to, one or more datastores, data repositories, databases, and/or other devices for storing information. These datastores may store information in any known way, such as, for example, by using one or more computer codes and/or languages, alphanumeric character strings, data sets, figures, tables, charts, links, documents, and/or the like. Further, in some embodiments, each datastore may include information associated with one or more applications, such as, for example, the processing datastore 338 storing information associated with the processing application 337 and/or the decisioning datastore 328 storing information associated with the decisioning application 327. In some embodiments, the processing datastore 338, the decisioning datastore 328, and/or transaction datastore 340 provides a real-time or near real-time representation of the information stored therein, so that, for example, when a processor (e.g., the processor 324, the processor 334, and the like) accesses one or more of those datastores, the information stored therein is current or nearly current. Each of the datastores can also dynamically store information, such that the information stored therein (e.g., daily ending balances, merchant category code lists, rules for determining when transactions should post to accounts, rules for determining whether transaction amounts should be included in daily ending balances, and the like) can be quickly and/or immediately added, deleted, changed, revised, updated, and/or the like.

Of course, the embodiment illustrated in FIG. 3 is exemplary and other embodiments of the present invention may vary. For example, in some embodiments, some or all of the portions of the system 300 are combined into a single portion. Specifically, in some embodiments, the decisioning apparatus 320 and the batch processing apparatus 330 are combined into a single apparatus that is configured to perform one or more (or all) of the same functions performed by those separate apparatuses. As another example, in some embodiments, the decisioning apparatus 320 and the ATM 304 are combined into a single apparatus that is configured to perform one or more (or all) of the same functions performed by those separate apparatuses. Likewise, in some embodiments, some or all of the portions of the system 300 are separated into two or more distinct portions.

In some embodiments, the various portions of the system 300 may be maintained by the same or separate parties. For example, in some embodiments, a financial institution maintains the batch processing apparatus 330, and a vendor maintains the decisioning apparatus 320. However, in other embodiments, a financial institution maintains both the batch processing apparatus 330 and the decisioning apparatus 320. Also, in some alternative embodiments, a banking associate, teller, customer service representative, and/or some other person maintains and/or has access to the decisioning apparatus 320 in order to perform and/or otherwise facilitate the performance of one or more of the embodiments of the present invention.

The system 300 (and/or one or more portions of the system 300) may include and/or implement any embodiment of the present invention described and/or contemplated herein. For example, in some embodiments, the system 300 (and/or one or more portions of the system 300) is configured to implement any one or more embodiments of the process flow 100 described and/or contemplated herein in connection with FIG. 1, any one or more embodiments of the process flow 200 described and/or contemplated herein in connection with FIGS. 2 and 2A, and/or any one or more embodiments of the process flow 400 described and/or contemplated herein in connection with FIG. 4.

As a specific example, in some embodiments, the decisioning apparatus 320 is configured to: (a) receive transaction information associated with a transaction (e.g., from the account datastore 340, from the POS device 303, and the like), as represented by block 110 in FIG. 1; (b) determine, based at least partially on the transaction information, that the transaction involves the account 342, occurred after a daily cutoff time on a first day, has a predetermined transaction type (e.g., cash-related transaction, purchase transaction, and the like), and includes a transaction amount, as represented by block 120; (c) designate, based at least partially on the determining that the transaction occurred after the daily cutoff time, the transaction for posting to the account 342 on a second day, where the second day is any day after the first day, as represented by block 130; and/or (d) designate, based at least partially on the determining that the transaction has the predetermined transaction type (e.g., cash-related transaction, and the like), the transaction amount for inclusion in the daily ending balance for the account 342 for the first day, as represented by block 140. In addition, in such embodiments, the batch processing apparatus 330 is configured to: (e) determine the daily ending balance for the account 342 for the first day based at least partially on the transaction amount, as represented by block 150 of FIG. 1; and/or (f) post the transaction to the account 342 on the second day, as represented by block 160. In some embodiments, the decisioning apparatus 320 is configured to configure a batch job for daily processing, as represented by block 275 of FIG. 2A. Additionally or alternatively, in some embodiments, the batch processing apparatus 330 is configured to execute a batch job, as represented by block 280 of FIG. 2A. In accordance with some embodiments, the decisioning apparatus 320 and the batch processing apparatus 330 are each configured to send and/or receive information (e.g., data, images, messages, instructions, and the like) to and/or from each other, such that information sent from the first apparatus to the second apparatus can trigger that second apparatus to perform one or more portions of any of the embodiments described and/or contemplated herein.

Referring now to FIG. 4, an exemplary mixed block and flow diagram of a system 400 is provided, in accordance with an embodiment of the present invention. The system 400 includes an ATM 401, POS device 402, decisioning server 403, and batch processing server 404. Each of these apparatuses includes one or more communication interfaces, processors, memory devices, applications, and/or datastores, as previously described herein. In addition, these apparatuses are operatively connected to each other via one or more networks. In this example embodiment, the ATM 401, the decisioning server 403, and the batch processing server 404 are each maintained by a bank, and the POS device 402 is maintained by a merchant. Although only one ATM and one POS device are illustrated in FIG. 4, it will be understood that the ATM 401 and the POS device 402 may represent one or more separate and/or different ATMs and one or more separate and/or different POS devices, respectively.

FIG. 4 also shows, in chronological order, various times during a single day, which include the beginning of day (12:00 am) 405, the daily cutoff time for ATM transactions (8:00 pm) 406, the daily cutoff time for purchase transactions (9:00 pm) 407, and the end of day (11:59 pm) 408. For simplicity, as shown in FIG. 4, the day that extends between the beginning of day 405 and the end of day 408 is referred to in this example embodiment as “Monday.” In addition, as shown, the day before the beginning of day 405 is “Sunday,” and the day after the end of day 408 is “Tuesday.” FIG. 4 also shows several transactions represented by blocks 410-435 that occur at the ATM 401 or the POS device 402. In this example embodiment, each of these transactions involves a customer of the bank and a checking account held by the customer, and the bank maintains the checking account for the benefit of the customer. As will be explained in more detail below, the system 400 is configured to process the transactions represented by blocks 410-435 based at least partially on when those transactions occur during the day on Monday relative to the daily cutoff times 406, 407.

As shown in FIG. 4, the customer first engages in a funds transfer transaction at the ATM 401, as represented by block 410. For example, in some embodiments, the customer uses the ATM to transfer funds out of the customer's checking account and into the customer's savings account. As shown in FIG. 4, the ATM funds transfer transaction occurs at 11:30 am, which is after the beginning of day 405 but before the ATM transaction daily cutoff time 406 (and before the end of day 408). Later, the customer engages in a purchase transaction at the POS device 402, as represented by block 415. For example, in some embodiments, the customer swipes a debit card through a merchant terminal to conduct a purchase transaction at a merchant store. As shown in FIG. 4, this purchase transaction occurs at 2:45 pm, which is before the purchase transaction daily cutoff time 407.

As represented by block 420, the customer also withdraws cash from the ATM 401 at 8:10 pm, which is after the ATM transaction daily cutoff time 406. It will be understood that the ATM involved in this cash withdrawal transaction may be different than the ATM involved in the funds transfer transaction. After withdrawing cash, the customer engages in a second purchase transaction at the POS device 402, as represented by block 425. The second purchase transaction occurs at 8:45 pm, which is before the purchase transaction daily cutoff time 407. As with the ATM, it will be understood that POS device involved in the second purchase transaction may be different than the POS device involved in the first purchase transaction. As shown in FIG. 4, after the second purchase transaction, the customer engages in a check deposit transaction at the ATM 401, as represented by block 430. For example, in some embodiments, the customer deposits a single check in the amount of $300 into his checking account at the ATM 401. As shown in FIG. 4, the ATM check deposit transaction occurs at 9:15 pm, which is after the ATM transaction daily cutoff time 406 but before the end of day 408. Later, after the check deposit transaction, the customer engages in a third purchase transaction at the POS device 402, as represented by block 435. As shown in FIG. 4, the third purchase transaction occurs at 10:45 pm, which is after the purchase transaction daily cutoff time 407 but before the end of day 408.

Thereafter, as represented by block 440, the decisioning server 403 is configured to identify which of the transactions represented by blocks 410-435 are before-cutoff transactions and which are after-cutoff, cash-related transactions (and, in some embodiments, which are neither). Specifically, in this example embodiment, the decisioning server 403 identifies the funds transfer transaction represented by block 410, the first purchase transaction represented by block 415, and the second purchase transaction represented by block 425 as before-cutoff transactions because each of those transactions occurred before their respective daily cutoff times 406, 407. In addition, the decisioning server 403 identifies the cash withdrawal transaction represented by block 420 as the only after-cutoff, cash-related transaction because that transaction occurred after the ATM transaction daily cutoff time 406 and involved cash. As shown in FIG. 4, in this example embodiment, the decisioning server 403 is configured to identify the before-cutoff transactions and the after-cutoff, cash-related transactions at 11:00 pm, which is after the transactions represented by blocks 410-435 occurred but before the end of day 408. Although not shown, in some embodiments, the decisioning server 403 is configured to designate the check deposit transaction represented by block 430 and the third purchase transaction represented by block 435 as inputs for the next day's (e.g., Tuesday's) daily batch job. Additionally or alternatively, in some embodiments, the decisioning server 403 is configured to determine that the check deposit transaction and the third purchase transaction should not be included in the daily ending balance for the checking account for Monday; instead, in such embodiments, the decisioning server 403 designates those transactions for inclusion in the daily ending balance for the checking account for Tuesday.

In addition to identifying the before-cutoff transactions and the after-cutoff, cash-related transactions, the decisioning server 403 is also configured to configure a daily batch job based at least partially on the identified transactions, as represented by block 445. More specifically, in this example embodiment, the decisioning server 403 configures the daily batch job by, in part, including information associated with the funds transfer transaction represented by block 410, the first purchase transaction represented by block 415, the second purchase transaction represented by block 425, and the cash withdrawal transaction represented by block 420 as input data into the daily batch job. In some embodiments, the information associated with the before-cutoff transactions is more detailed than the information associated with the after-cutoff, cash-related transaction. For example, in some embodiments, the information associated with the before-cutoff transactions includes the transaction amount, transaction description, and transaction date of those transactions, whereas the information associated with the after-cutoff, cash-related transaction only includes the transaction amount for the cash withdrawal transaction 420. In some embodiments, the transaction amount for the cash withdrawal transaction 420 represents the net amount of all the after-cutoff, cash-related transactions involving the checking account that occurred on Monday. In this example embodiment, the decisioning server 403 configures the daily batch job at 11:30 pm, which is before the end of day 408.

Once the daily batch job has been configured, the decisioning server 403 is configured to send the daily batch job to the batch processing server 404, as represented by block 450. In this example embodiment, the daily batch job is sent at 11:59 pm, which is at the end of day 408. Thereafter, the batch processing server 403 is configured to (e.g., scheduled to, and the like) execute the daily batch job at 2:00 am on Tuesday, as represented by block 455. More specifically, in this example embodiment, the batch processing server 404 is configured to post the before-cutoff transactions (e.g., the funds transfer transaction represented by block 410, the first purchase transaction represented by block 415, and the second purchase transaction represented by block 425, and the like) to the checking account on Monday. Here, the before-cutoff transactions are considered to post to the checking account on Monday even though the batch processing server 404 actually posts those transactions on Tuesday (i.e., after the end of day 408). This is because the transactions that occurred on Monday before their respective daily cutoff times are given a posting date of Monday, even though the transactions are actually posted to the checking account on Tuesday.

In addition to posting transactions, the batch processing server 404 can determine the daily ending balance for the checking account for Monday based at least partially on the before-cutoff transactions and the after-cutoff, cash-related transaction (i.e., the funds transfer transaction represented by block 410, the first purchase transaction represented by block 415, the second purchase transaction represented by block 425, and the cash withdrawal transaction represented by block 420). As shown in FIG. 4, the daily ending balance for the checking account for Monday is actually determined on Tuesday but is still considered to be Monday's daily ending balance because it is based at least partially on transactions that actually occurred on Monday. In addition to determining the daily ending balance, the batch processing server 404 can be configured to determine whether the checking account incurs a surpassed balance based at least partially on the daily ending balance for the checking account for Monday. In addition, as part of executing the Monday batch job, the batch processing server 404 can be configured to assess a surpassed balance payment based at least partially on whether the checking account has incurred an surpassed balance. It will be understood that the daily batch job for Monday may take several hours to execute because, for example, it has a very large amount of information stored therein (e.g., transaction information associated with the checking account as well as transaction information from other accounts maintained by the bank, and the like) and/or is configured to accomplish several different tasks (e.g., post transactions to accounts, determine daily ending balances, determine exceeded account thresholds, assess exceeded account threshold payments, and the like).

Of course, the embodiment illustrated in FIG. 4 is merely exemplary and other embodiments may vary without departing from the scope and spirit of the present invention. For example, in some embodiments, the decisioning server 403 is configured to identify the before-cutoff transactions and/or the after-cutoff, cash-related transactions when and/or immediately after those transactions occur and/or are authorized. As another example, in some embodiments, the decisioning server 403 is configured to configure Monday's daily batch job periodically and/or incrementally throughout the day on Monday instead of all at one time and/or near the end of day 408. As still another example, each of the times associated with the blocks 410-455 may be different in other embodiments. In addition, the beginning of day 405, the daily cutoff times 406, 407, and/or the end of day 408 may be different and/or defined differently in other embodiments of the present invention. For example, in some alternative embodiments, the beginning of day for Monday is defined as 3:00 am on Monday and the end of day for Monday is defined as 2:59 am on Tuesday. As another example, in some alternative embodiments, one or more of the portions of the process flow performed by the decisioning server 403 are performed instead by the batch processing server 404, and/or vice versa.

Although many embodiments of the present invention have been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, and the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, and the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving transaction information associated with a transaction;
determining a channel associated with the transaction;
determining, based at least partially on the transaction information, that the transaction involves an account, occurred after a daily cutoff time associated with the channel on a first day, comprises a predetermined transaction type, and comprises a transaction amount;
designating, using a processor and based at least partially on the determining that the transaction occurred after the daily cutoff time and comprises the predetermined transaction type, the transaction amount for inclusion in the daily ending balance for the account for the first day, the transaction amount not for inclusion in a posted balance for the account for the first day;
updating an available balance for the account for the first day based on the transaction amount;
receiving transaction information associated with another transaction, wherein the other transaction occurred after the transaction; and
executing the other transaction based on the available balance for the account for the first day, and not based on the posted balance for the account for the first day.

2. The method of claim 1, further comprising:
designating, based at least partially on the determining that the transaction occurred after the daily cutoff time, the transaction for posting to the account on a second day, wherein the second day is any day after the first day.

3. The method of claim 2, further comprising:
posting the transaction to the account on the second day.

4. The method of claim 3, wherein the posting the transaction to the account on the second day comprises assigning a posting date to the transaction, wherein the posting date is the second day.

5. The method of claim 1, further comprising:
configuring a batch job for processing, wherein the configuring comprises inputting a determined amount into the batch job, wherein the determined amount is based at least partially on the transaction amount associated with the transaction, and wherein the batch job, when executed by a processor, causes the processor to determine the daily ending balance based at least partially on the determined amount.

6. The method of claim 5, wherein the determined amount is the transaction amount.

7. The method of claim 5, wherein the determined amount is the sum of the transaction amount and one or more other transaction amounts, wherein the one or more other transaction amounts are associated with one or more transactions that involve the account, occurred after the daily cutoff time on the first day, and comprise the predetermined transaction type.

8. The method of claim 1, further comprising:
determining, using a processor, the daily ending balance based at least partially on the transaction amount.

9. The method of claim 8, further comprising:
posting the daily ending balance to an electronic banking account associated with the account.

10. The method of claim 8, further comprising:
determining, using a processor and based at least partially on the daily ending balance, that the account comprises an overage.

11. The method of claim of claim 10, further comprising:
assessing, based at least partially on the determining that the account comprises the overage, an assessment associated with the overage.

12. The method of claim 1, wherein the predetermined transaction type comprises at least one of a cash withdrawal, cash deposit, or funds transfer.

13. The method of claim 1, further comprising:
receiving second transaction information associated with a second transaction;
determining, based at least partially on the second transaction information, that the second transaction involves the account, occurred before the daily cutoff time on the first day, and comprises a second transaction amount; and
designating, using a processor and based at least partially on the determining that the second transaction occurred before the daily cutoff time, the second transaction amount for inclusion in the daily ending balance.

14. The method of claim 13, further comprising:
designating, based at least partially on the determining that the second transaction occurred before the daily cutoff time, the second transaction for posting to the account on the first day.

15. The method of claim 1, further comprising:
receiving second transaction information associated with a second transaction;
determining, based at least partially on the second transaction information, that the second transaction involves the account, occurred after the daily cutoff time on the first day, comprises a second transaction amount, and does not comprise the predetermined transaction type; and
designating, using a processor and based at least partially on the determining that the second transaction occurred after the daily cutoff time and does not comprise the predetermined transaction type, the second transaction amount for inclusion in the daily ending balance for the account for a second day, wherein the second day is any day after the first day.

16. The method of claim 1, wherein the transaction was conducted through a first channel, wherein the daily cutoff time is associated with the first channel, and wherein the method further comprises:
receiving second transaction information associated with a second transaction;
determining, based at least partially on the second transaction information, that the second transaction involves the account, comprises a second transaction amount, and occurred after the daily cutoff time but before a second daily cutoff time on the first day, wherein the second daily cutoff time is associated with a second channel through which the second transaction was conducted; and
designating, using a processor and based at least partially on the determining that the second transaction occurred before the second daily cutoff time, the second transaction amount for inclusion in the daily ending balance.

17. An apparatus comprising:
a communication interface configured to receive transaction information associated with a transaction; and
a processor operatively connected to the communication interface and configured to:
determine a channel associated with the transaction;
determine, based at least partially on the transaction information, that the transaction involves an account, occurred after a daily cutoff time associated with the channel on a first day, comprises a predetermined transaction type, and comprises a transaction amount;
designate, based at least partially on the processor determining that the transaction occurred after the daily cutoff time and comprises the predetermined transaction type, the transaction amount for inclusion in the daily ending balance for the account for the first day, the transaction amount not for inclusion in a posted balance for the account for the first day;
update an available balance for the account for the first day based on the transaction amount;
receive transaction information associated with another transaction, wherein the other transaction occurred after the transaction; and
execute the other transaction based on the available balance for the account for the first day, and not based on the posted balance for the account for the first day.

18. The apparatus of claim 17, wherein the processor is further configured to:
designate, based at least partially on the processor determining that the transaction occurred after the daily cutoff time, the transaction for posting to the account on a second day, wherein the second day is any day after the first day.

19. The apparatus of claim 18, wherein the processor is further configured to:
post the transaction to the account on the second day.

20. The apparatus of claim 17, wherein the processor is further configured to:
configure a batch job for processing by inputting a determined amount into the batch job, wherein the determined amount is based at least partially on the transaction amount, and wherein the batch job, when executed by a second processor, causes the second processor to determine the daily ending balance based at least partially on the determined amount.

21. The apparatus of claim 17, wherein the processor is further configured to:
determine the daily ending balance based at least partially on the transaction amount.

22. The apparatus of claim 21, wherein the processor is further configured to:
post the daily ending balance to an electronic banking account associated with the account.

23. The apparatus of claim 21, wherein the processor is further configured to:
determine, based at least partially on the daily ending balance, that the account comprises an overage.

24. The apparatus of claim 17, wherein the communication interface is further configured to receive second transaction information associated with a second transaction, and wherein the processor is further configured to:
determine, based at least partially on the second transaction information, that the second transaction involves the account, occurred before the daily cutoff time on the first day, and comprises a second transaction amount; and
designate, based at least partially on the processor determining that the second transaction occurred before the daily cutoff time, the second transaction amount for inclusion in the daily ending balance.

25. The apparatus of claim 24, wherein the processor is further configured to:
designate, based at least partially on the processor determining that the second transaction amount occurred before the daily cutoff time, the second transaction for posting to the account on the first day.

26. The apparatus of claim 17, wherein the communication interface is further configured to receive second transaction information associated with a second transaction, and wherein the processor is further configured to:
determine, based at least partially on the second transaction information, that the second transaction involves the account, occurred after the daily cutoff time on the first day, comprises a second transaction amount, and does not comprise the predetermined transaction type; and
designate, based at least partially on the processor determining that the second transaction occurred after the daily cutoff time and does not comprise the predetermined transaction type, the second transaction amount for inclusion in the daily ending balance for the account for a second day, wherein the second day is any day after the first day.

27. The apparatus of claim 17, wherein the transaction was conducted through a first channel, wherein the daily cutoff time is associated with the first channel, wherein the communication interface is further configured to receive second transaction information associated with a second transaction, and wherein the processor is further configured to:
determine, based at least partially on the second transaction information, that the second transaction involves the account, comprises a second transaction amount, and occurred after the daily cutoff time but before a second daily cutoff time on the first day, wherein the second daily cutoff time is associated with a second channel through which the second transaction was conducted; and
designate, based at least partially on the processor determining that the second transaction occurred before the second daily cutoff time, the second transaction amount for inclusion in the daily ending balance.

28. A computer program product comprising a non-transitory computer-readable medium, wherein the non-transitory computer-readable medium comprises one or more computer-executable program code portions that, when executed by a computer, cause the computer to:
receive transaction information associated with a transaction;
determine a channel associated with the transaction;
determine, based at least partially on the transaction information, that the transaction involves an account, occurred after a daily cutoff time associated with the channel on a first day, comprises a predetermined transaction type, and comprises a transaction amount;
designate, based at least partially on the computer determining that the transaction occurred after the daily cutoff time and comprises the predetermined transaction type, the transaction amount for inclusion in the daily ending balance for the account for the first day, the transaction amount not for inclusion in a posted balance for the account for the first day;
update an available balance for the account for the first day based on the transaction amount;
receive transaction information associated with another transaction, wherein the other transaction occurred after the transaction; and
execute the other transaction based on the available balance for the account for the first day, and not based on the posted balance for the account for the first day

29. The computer program product of claim 28, wherein the one or more computer-executable program code portions, when executed by the computer, cause the computer to:
designate, based at least partially on the computer determining that the transaction occurred after the daily cutoff time, the transaction for posting to the account on a second day, wherein the second day is any day after the first day.

30. The computer program product of claim 28, wherein the one or more computer-executable program code portions, when executed by the computer, cause the computer to:
configure a batch job for processing by inputting a determined amount into the batch job, wherein the determined amount is based at least partially on the transaction amount, and wherein the batch job, when executed by a second computer, causes the second computer to determine the daily ending balance based at least partially on the determined amount.

31. The computer program product of claim 28, wherein the one or more computer-executable program code portions, when executed by the computer, cause the computer to:
determine the daily ending balance based at least partially on the transaction amount.

32. A system comprising:
a decisioning apparatus configured to:
receive transaction information associated with a first group of transactions involving an account;
determine a channel associated with the first group of transactions;
determine, based at least partially on the transaction information, that each transaction in the first group occurred after a daily cutoff time associated with the channel on a first day, comprises a predetermined transaction type, and comprises a transaction amount;
determine, based at least partially on determining that each of the transactions in the first group occurred after the daily cutoff time and comprises the predetermined transaction type, that the daily ending balance for the account for the first day should be based at least partially on the transactions in the first group, and that the posted balance for the account for the first day should not be based on the transactions in the first group;
determine, based at least partially on determining that the daily ending balance should be based at least partially on the transactions in the first group, a net amount for the first group, wherein the net amount comprises the sum of the transaction amounts in the first group;
update an available balance for the account for the first day based on the net amount;
receiving transaction information associated with another transaction, wherein the other transaction occurred after the first group of transactions;
execute the other transaction based on the available balance for the account for the first day, and not based on the posted balance for the account for the first day; and
configure a batch job for processing by inputting the net amount into the batch job; and
a batch processing apparatus operatively connected to the decisioning apparatus and configured to:
receive the batch job; and
execute the batch job to determine the daily ending balance for the account for the first day based at least partially on the net amount.

33. The system of claim 32, wherein the batch processing apparatus is further configured to:
post the transactions in the first group to the account on a second day, wherein the second day is any day after the first day.

34. The system of claim 32, wherein the decisioning apparatus is further configured to:
receive second transaction information associated with a second group of transactions involving the account;
determine, based at least partially on the second transaction information, that each transaction in the second group occurred before the daily cutoff time on the first day and comprises a transaction amount;
determine, based at least partially on determining that each transaction in the second group occurred before the daily cutoff time, that the daily ending balance should be based at least partially on the transactions in the second group; and
configure the batch job for processing by inputting each transaction amount from the second group into the batch job.

35. A method comprising:
receiving transaction information associated with a transaction;
determining a channel associated with the transaction;
determining, based at least partially on the transaction information, that the transaction involves an account, occurred after a daily cutoff time associated with the channel on a first day, and comprises a transaction amount, the transaction amount for inclusion in the daily ending balance for the account for the first day, the transaction amount not for inclusion in a posted balance for the account for the first day;
determining, using a processor, a daily ending balance for the account for the first day based at least partially on the transaction amount and based at least partially on the transaction occurring after the daily cutoff time;
updating an available balance for the account for the first day based on the transaction amount;
receiving transaction information associated with another transaction, wherein the other transaction occurred after the transaction;
executing the other transaction based on the available balance for the account for the first day, and not based on the posted balance for the account for the first day; and
posting the transaction to the account on a second day, wherein the second day is any day after the first day, wherein a first daily cutoff time associated with a first channel is different from a second daily cutoff time associated with a second channel.

36. The method of claim 35, wherein the determining and the posting are performed as part of executing a batch job.

37. The method of claim 35, further comprising:
determining, based at least partially on the daily ending balance, that the account comprises an overage.

38. The method of claim of claim 37, further comprising:
assessing, based at least partially on the determining that the account comprises the overage, an assessment associated with the overage.

39. The method of claim 35, wherein the posting the transaction to the account comprises hard-posting the transaction to the account.
